(19) United States
(12) Patent Application Publication
(10) Pub. No.: US 2007/0248888 A1
(43) Pub. Date: Oct. 25, 2007

(54) High-Performance All-Solid Lithium Battery

(75) Inventors: Yoshikatsu Seino, Chiba (JP); Kazunori Takada, Ibaraki (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Idemitsu Kosan Co., Ltd., Chiyoda-ku (JP); National Institute for Materials Science, Tsukuba-shi (JP)

(21) Appl. No.: 11/628,030

(22) PCT Filed: Jun. 2, 2005
(86) PCT No.: PCT/JP05/10134

§ 371 Date: Nov. 30, 2006

(30) Foreign Application Priority Data
Jun. 4, 2004 (JP) 2004-167453
Aug. 11, 2004 (JP) 2004-234201

(51) Int. Cl. H01M 6/18

(52) U.S. Cl. 429/304

(57) ABSTRACT

The present invention provides a method of efficiently producing a lithium ion conductive inorganic solid electrolyte having high ionic conductivity, including: conducting a melt reaction of lithium sulfide containing 0.15 mass % or less of each of a lithium salt of sulfur oxide and lithium N-methylaminobutyrate, and one or more components selected from diphosphorus pentasulfide, elemental phosphorus, and elemental sulfur; rapidly cooling the resultant; and subjecting the resultant to heat treatment, and a high-performance lithium battery using the electrolyte. In particular, the present invention provides a high-performance lithium battery having high energy density, which is obtained by using a positive electrode active material having an operating potential of 3 V or more, a negative electrode active material having a reduction potential of 0.5 V or less, and a lithium ion conductive inorganic solid electrolyte in contact with at least the negative electrode active material, the lithium ion conductive inorganic solid electrolyte being produced from lithium sulfide and one or more components selected from diphosphorus pentasulfide, elemental phosphorus, and elemental sulfur, and which can be used as a monolayer.

### TECHNICAL FIELD

The present invention relates to a method of producing a lithium ion conductive inorganic solid electrolyte using high purity lithium sulfide, and more specifically, to a method of producing a lithium ion conductive inorganic solid electrolyte using lithium sulfide containing small amounts of impurities such as a lithium salt of sulfur oxide and lithium N-methylaminobutyrate (LMAB), and to a lithium battery using the electrolyte.

Further, the present invention relates to a high-performance all-solid lithium battery using as a solid electrolyte a lithium ion conductive inorganic solid electrolyte produced from lithium sulfide and one or more components selected from diphosphorus pentasulfide, elemental phosphorus, and elemental sulfur, and more specifically, to a lithium battery using a positive electrode active material having an operating potential of 3 V or more, a negative electrode active material having a reduction potential (a potential of a negative electrode active material) of 0.5 V or less, and a lithium ion conductive inorganic solid electrolyte in contact with at least the negative electrode active material produced from lithium sulfide and one or more components selected from diphosphorus pentasulfide, elemental phosphorus, and elemental sulfur.

### BACKGROUND ART

In recent years, a demand for a high-performance lithium secondary battery to be used for a personal digital assistance, a portable electronic device, a domestic small electronic energy storage device, a two-wheeled motor vehicle using a motor as a power source, an electric automobile, a hybrid electric automobile, or the like has increased.

A secondary battery refers to a battery which can be charged and discharged.

With expansion of use, further improvements in safety and high-performance of the secondary battery have been required.

An inorganic solid electrolyte is inflammable by nature and is a highly safe material compared with an electrolyte generally used.

However, the inorganic solid electrolyte exhibits slightly degraded electrochemical performance than that of the electrolyte generally used, and thus, the performance of the inorganic solid electrolyte must be further improved.

An effective method of assuring safety of a lithium battery involves use of an inorganic solid electrolyte in place of an organic solvent electrolyte.

The inorganic solid electrolyte is inflammable by nature and is a highly safe material compared with an organic solvent electrolyte generally used, and development of a highly safe all-solid lithium battery using the inorganic solid electrolyte has been desired.

Various methods of producing lithium sulfide are known (Patent Document 1, for example).

This method involves production of lithium sulfide in an aprotic organic solvent such as N-methyl-2-pyrrolidone (NMP) and allows continuous steps, and thus is an economical and simple method of producing lithium sulfide.

However, lithium sulfide to be obtained contains lithium N-methylaminobutyrate (LMAB) which is an impurity derived from NMP mixed therein.

Further, there is known a method of reacting lithium hydroxide and a gaseous sulfur source at a temperature of 130 to 445° C. (Patent Document 2).

In this method, a lithium salt of sulfur oxide (such as lithium sulfite, lithium sulfate, and lithium thiosulfate) or the like produced in a production process is mixed into lithium sulfide.

A complete vitreous electrolyte cannot be obtained easily by producing a solid electrolyte by conducting a melt reaction of lithium sulfide and diphosphorus pentasulfide, for example, and rapidly cooling the resultant because of effects of impurities.

That is, the obtained solid electrolyte is a crystallized product having low ionic conductivity. Thus, the solid electrolyte used as a lithium battery solid electrolyte cannot exhibit target battery performance.

A lithium ion conductive solid electrolyte to be used for an all-solid lithium battery preferably has high ionic conductivity.

Examples of such the solid electrolyte include: sulfide glass having an ionic conductivity of 10⁻³ S/cm found in 1980's such as LiI—Li₂S—P₂S₅, LiI—Li₂S—B₂S₃, or LiI—Li₂S—SiS₂; and Li₃PO₄—Li₂S—SiS₂ or Li₄SiO₄—Li₂S—SiS₂ found recently.

However, not much has been mentioned regarding selection of a solid electrolyte suitable for a specific electrode active material.

There is reported a possibility of an all-solid secondary battery using a carbon material as a negative electrode active material and Li₃PO₄—Li₂S—SiS₂ as a solid electrolyte (Non-patent Document 1, for example). However, the solid electrolyte and the negative electrode active material react, and a reductive decomposition reaction of the solid electrolyte proceeds. Thus, there is no possibility of a practical secondary battery with this combination.

There are reported various all-solid secondary batteries each using a carbon material as a negative electrode active material and lithium cobaltate (LiCoO₂) as a positive electrode active material (Non-patent Document 2, for example).

Those all-solid secondary batteries each employ two kinds of electrolytes of Li₂S—P₂S₅—LiI and Li₂S—GeS₂—P₂S₅ in a bilayer as a solid electrolyte to produce a high capacity, high potential (4 V class) all-solid lithium battery.

The reasons for use of such the solid electrolyte are described below.

In the structure of the solid electrolyte for the all-solid secondary battery using carbon as a negative electrode active material, in the case where a solid electrolyte obtained by using silicon sulfide or germanium sulfide as a raw material is used, a reaction in which lithium ions are inserted between layers of the carbon material during charge occurs and a reduction reaction of silicon or germanium occurs as a side reaction.

That is, in the case where the solid electrolyte containing silicon or germanium in Li₂S—SiS₂, Li₂S—GeS₂, or the like is used, a current having flowed during charge of the battery is consumed in the insertion reaction of lithium ions into the carbon material and in the reduction reaction of silicon or germanium.

Of the reactions, the latter reaction is not reversible. Of a charged electric quantity, an electric quantity consumed in the reduction reaction of silicon or germanium cannot be extracted during charge.

As improvements for the problems described above, in an all-solid lithium secondary battery using a carbon material or a substance containing lithium ions inserted between layers of the carbon material as a negative electrode active material, a substance containing no silicon or germanium is used as a solid electrolyte in contact with the negative electrode active material, and phosphorus sulfide (P₂S₅) is used as a raw material for an electrolyte.

Phosphorus sulfide is used because phosphorus is a hardly reduced element.

In the case where the negative electrode active material described above is used, Li₂S—P₂S₅—LiI is used as a solid electrolyte having high ionic conductivity.

However, in use of lithium iodide (LiI) for increasing an ionic conductivity, an oxidation potential of the electrolyte is 2.9 V. Thus, use of a positive electrode active material having a battery operating potential of 3 V or more causes an oxidative decomposition reaction and inhibits operation as a secondary battery.

Therefore, a compound such as lithium iodide is preferably not used.

In the case where a carbon material is used as a negative electrode active material having a reduction potential of 0.5 V or less, and a positive electrode active material having an operating potential of 3 V or more is used, the problems can be solved by using two kinds of electrolytes of Li₂S—P₂S₅—LiI on a negative electrode side and Li₂S—GeS₂—P₂S₅ on a positive electrode side. However, the thinner the electrolyte is, the more the battery performance improves. Thus, the electrolyte is preferably a monolayer than a bilayer.

That is, an all-solid lithium battery having high potential of 4 V class and high energy density and including an electrolyte as a monolayer is expected to be obtained by, for example: using a carbon material represented by a graphite intercalation compound as a negative electrode active material having a reduction potential of 0.5 V or less, and a compound such as lithium cobaltate as a positive electrode active material having an operating potential of 3 V or more; and selecting a solid electrolyte.

The graphite intercalation compound has a theoretical capacity of 372 mAh/g and an electronegative potential of about 0.1 V, and lithium cobaltate has a potential of 4 V with respect to a lithium potential with release of lithium ions.

Non-patent Document 1: Kazunori Takada, Satoshi Naknano, Taro Inada, Akihisa Kajiyama, Hideki Sasaki, Shigeo Kondo and Mamoru Watanabe, Journal of Electrochemical, 150(3)A274-A277(2003)

Non-patent Document 2: Kazunori Takada, Taro Inada, Akihisa Kajiyama, Hideki Sasaki, Shigeo Kondo, Mamoru Watanabe, Masahiro Murayama, Ryoji Kanno, Solid State Ionics 158(2003)269-274

Patent Document 1: JP 07-330312 A

Patent Document 2: JP 09-283156 A

### DISCLOSURE OF THE INVENTION

The present invention has been made in view of the above-mentioned circumstances, and an object of the present invention is therefore to provide a novel and efficient method of producing a lithium ion conductive inorganic solid electrolyte having high ionic conductivity, and a high-performance lithium battery using the electrolyte.

Another object of the present invention is to provide an all-solid lithium battery having high energy density by developing a high-performance solid electrolyte which can be used as a monolayer.

The inventors of the present invention have conducted extensive studies for attaining the objects described above, and have found that a lithium ion conductive inorganic solid electrolyte having high ionic conductivity can be obtained by: conducting a melt reaction of high purity lithium sulfide and one or more components selected from diphosphorus pentasulfide, elemental phosphorus, and elemental sulfur; rapidly cooling the resultant; and subjecting the resultant to heat treatment.

The inventors of the present invention have also conducted extensive studies for attaining the objects described above, and have found that the objects described above can be attained by: using the lithium ion conductive inorganic solid electrolyte produced from lithium sulfide and one or more components selected from diphosphorus pentasulfide, elemental phosphorus, and elemental sulfur as a solid electrolyte; and using a positive electrode active material having an operating potential of 3 V or more and a negative electrode active material having a reduction potential of 0.5 V or less.

The present invention has been completed based on these findings.

That is, the present invention provides the following.

1. A method of producing a vitreous electrolyte, including: conducting a melt reaction of lithium sulfide containing 0.15 mass % or less of each of a lithium salt of sulfur oxide and lithium N-methylaminobutyrate, and one or more components selected from diphosphorus pentasulfide, elemental phosphorus, and elemental sulfur; and rapidly cooling the resultant.

2. A method of producing a vitreous electrolyte according to the above-mentioned item (1), in which the melt reaction is conducted on 50 to 80 mol % of lithium sulfide and 20 to 50 mol % of one or more components selected from diphosphorus pentasulfide, elemental phosphorus, and elemental sulfur.

3. A method of producing a vitreous electrolyte according to the above-mentioned item (1) or (2), in which a cooling rate is 1 to 10,000 K/sec.

4. A method of producing a lithium ion conductive inorganic solid electrolyte including subjecting the vitreous electrolyte obtained by the method according to any one of the above-mentioned items (1) to (3) to heat treatment.

5. A method of producing a lithium ion conductive inorganic solid electrolyte according to the above-mentioned item (4), in which the heat treatment is conducted at 170 to 370° C.

6. A lithium battery, which is produced by using the vitreous electrolyte obtained by the method according to any one of the above-mentioned items (1) to (3).

7. A lithium battery, which is produced by using the lithium ion conductive inorganic solid electrolyte obtained by the method according to the above-mentioned item (4) or (5).

8. A lithium battery, which is obtained by using a positive electrode active material having an operating potential of 3 V or more, a negative electrode active material having a reduction potential of 0.5 V or less, and a lithium ion conductive inorganic solid electrolyte in contact with at least the negative electrode active material, the lithium ion conductive inorganic solid electrolyte being produced from lithium sulfide and one or more components selected from diphosphorus pentasulfide, elemental phosphorus, and elemental sulfur.

9. A lithium battery according to the above-mentioned item (8), in which: lithium sulfide is obtained by reacting lithium hydroxide and hydrogen sulfide in an organic solvent, removing hydrogen sulfide from the resultant, then purifying the resultant; and lithium sulfide contains a total content of a lithium salt of sulfur oxide of 0.15 mass % or less and a content of lithium N-methylaminobutyrate of 0.15 mass % or less.

The present invention can provide a lithium ion conductive inorganic solid electrolyte having high conductivity of an ionic conductivity in a 1×10⁻³ (S/cm) order by: conducting a melt reaction of lithium sulfide containing 0.15 mass % or less of each of a lithium salt of sulfur oxide and lithium N-methylaminobutyrate, and one or more components selected from diphosphorus pentasulfide, elemental phosphorus, and elemental sulfur; rapidly cooling the resultant; and subjecting the resultant to heat treatment. Further, in the present invention, a high-performance lithium battery can be produced by using the electrolyte.

Further, in the present invention, the lithium ion conductive inorganic solid electrolyte produced by using lithium sulfide and one or more components selected from diphosphorus pentasulfide, elemental phosphorus, and elemental sulfur as a raw material can be used as a monolayer, and a high-performance all-solid lithium battery can easily be produced by using a positive electrode active material having an operating potential of 3 V or more and a negative electrode active material having a reduction potential of 0.5 V or less.

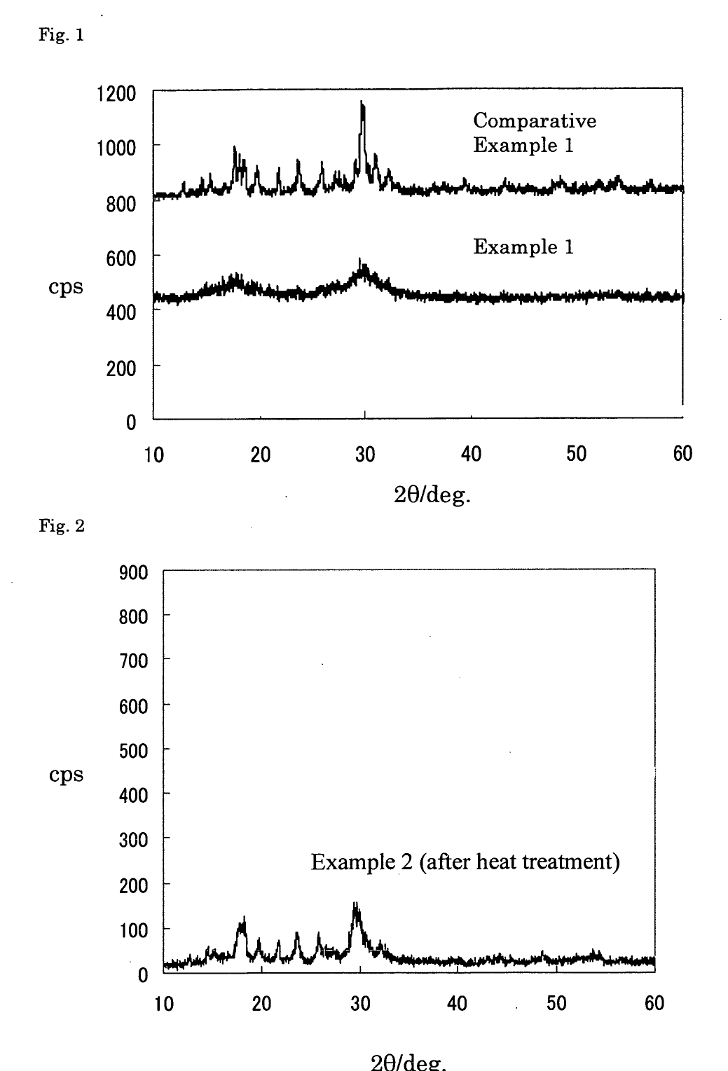

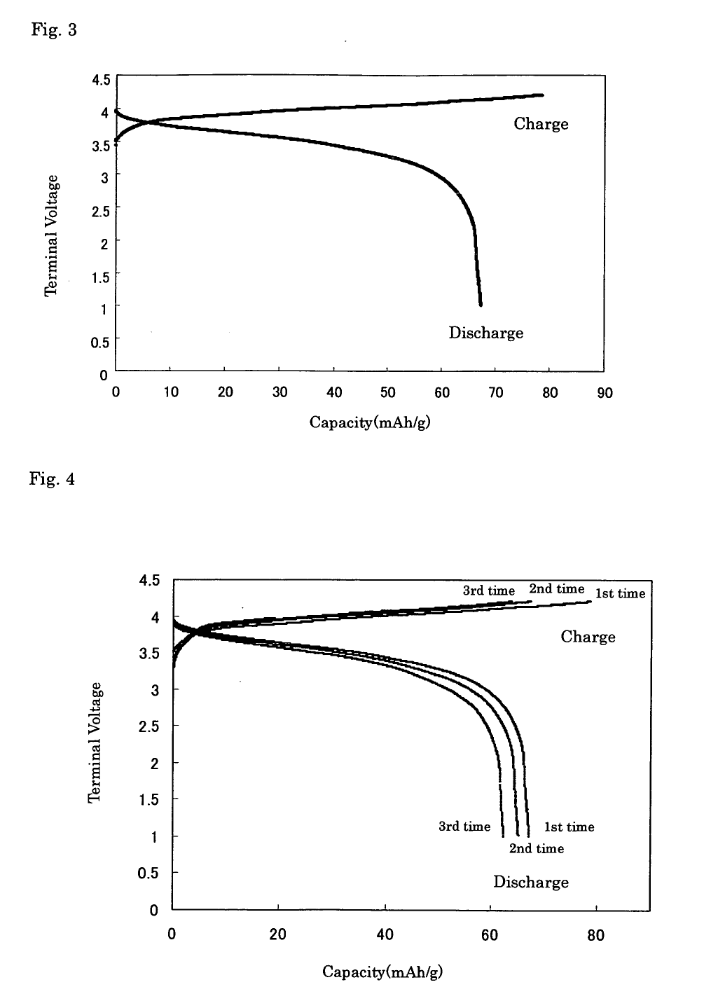

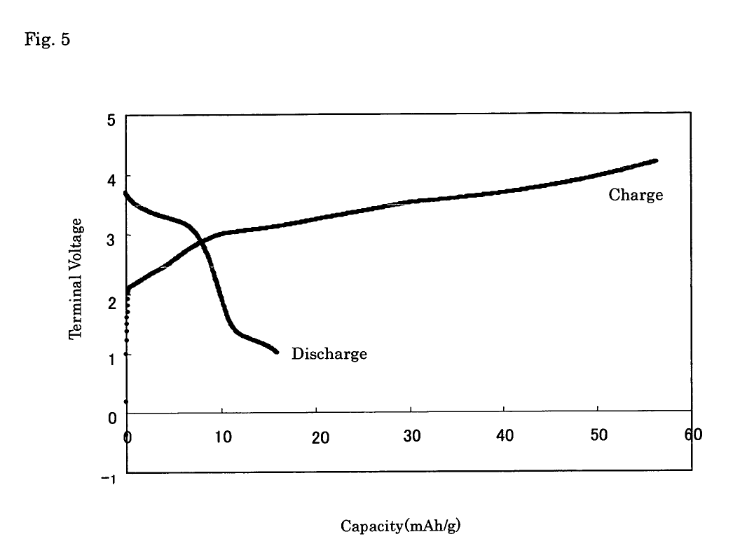

### BRIEF DESCRIPTION OF THE DRAWINGS

[FIG. 1] A diagram showing X-ray diffraction patterns of powder samples of Example 1 and Comparative Example 1.

[FIG. 2] A diagram showing an X-ray diffraction pattern of a powder sample of Example 2.

[FIG. 3] A diagram showing charge and discharge properties of a battery obtained in Example 3.

[FIG. 4] A diagram showing charge and discharge cycle properties of the battery obtained in Example 3.

[FIG. 5] A diagram showing charge and discharge properties of a battery obtained in Comparative Example 3.

### BEST MODE FOR CARRYING OUT THE INVENTION

Invention 1 will be described below.

A vitreous electrolyte of the present invention can be produced by: conducting a melt reaction of high purity lithium sulfide and one or more components selected from diphosphorus pentasulfide, elemental phosphorus, and elemental sulfur; and rapidly cooling the resultant.

High purity lithium sulfide to be used in the present invention contains a total content of a lithium salt of sulfur oxide of 0.15 mass % or less, and preferably 0.1 mass % or less, and a content of lithium N-methylaminobutyrate of 0.15 mass % or less, and preferably 0.1 mass % or less.

In the case where the total content of a lithium salt of sulfur oxide is 0.15 mass % or less, an electrolyte to be obtained is vitreous (completely amorphous).

That is, in the case where the total content of a lithium salt of sulfur oxide is more than 0.15 mass %, an electrolyte to be obtained is a crystallized product having low ionic conductivity from the beginning.

Further, no changes occur even when the crystallized product is subjected to the following heat treatment, and a lithium ion conductive inorganic solid electrolyte having high ionic conductivity cannot be obtained.

In the case where the content of lithium N-methylaminobutyrate is 0.15 mass % or less, a degraded product of lithium N-methylaminobutyrate does not degrade cycle performance of a lithium secondary battery.

Thus, for obtaining an electrolyte having high ionic conductivity, lithium sulfide containing reduced impurities must be used.

A mixed (melted) molar ratio of the lithium sulfide to one or more components selected from diphosphorus pentasulfide, elemental phosphorus, and elemental sulfur is generally 50:50 to 80:20, and preferably 60:40 to 75:25.

A melt reaction temperature of the above-mentioned mixture is generally 500 to 1,000° C., preferably 600 to 1,000° C., and more preferably 900 to 1,000° C., and a melt reaction time is generally 1 hour or more, and preferably 6 hours or more.

A rapid cooling temperature of the reaction product is generally 10° C. or lower, and preferably 0° C. or lower, and a cooling rate thereof is about 1 to 10,000 K/sec, and preferably 1 to 1,000 K/sec.

The thus-obtained electrolyte is vitreous (completely amorphous) and generally has an ionic conductivity of 1.0×10⁻⁵ to 8.0×10⁻⁵ (S/cm).

The lithium ion conductive inorganic solid electrolyte of the present invention can be produced by subjecting the vitreous electrolyte of the present invention to heat treatment.

A heat treatment temperature is generally about 170 to 370° C., preferably 180 to 330° C., and more preferably 200 to 290° C. A heat treatment time varies depending on the heat treatment temperature, but is generally 1 min or more, and preferably 5 min to 24 hours.

A partially or completely crystallized lithium ion conductive inorganic solid electrolyte can be obtained through the heat treatment.

The thus-obtained lithium ion conductive inorganic solid electrolyte generally has an ionic conductivity of 7.0×10⁻⁴ to 3.0×10⁻³ (S/cm).

A lithium battery having excellent long-term stability can be obtained by using the vitreous electrolyte and lithium ion conductive inorganic solid electrolyte each having excellent properties as described above.

As a method of producing a lithium battery by using the vitreous electrolyte and lithium ion conductive inorganic solid electrolyte obtained by the method of the present invention, a conventionally known method may be employed.

A method of producing lithium sulfide to be used in the present invention is not particularly limited as long as it is a method capable of reducing the above-mentioned impurities.

For example, lithium sulfide may be obtained by purifying lithium sulfide produced by the following methods.

Of the following production methods, method a or b is particularly preferred.

a. A method involving: reacting lithium hydroxide and hydrogen sulfide in an aprotic organic solvent at 0 to 150° C. to form lithium hydrosulfide; and removing hydrogen sulfide from the reaction liquid at 150 to 200° C. (Patent Document 1).

b. A method involving reacting lithium hydroxide and hydrogen sulfide in an aprotic organic solvent at 150 to 200° C. to form lithium sulfide directly (Patent Document 1).

c. A method involving reacting lithium hydroxide and a gaseous sulfur source at a temperature of 130 to 445° C. (Patent Document 2).

A method of purifying lithium sulfide obtained as described above is not particularly limited.

A preferred example of the purification method is a method described in Japanese Patent Application No. 2003-363403.

To be specific, lithium sulfide obtained as described above is washed with an organic solvent at a temperature of 100° C. or higher.

The organic solvent is used at a temperature of 100° C. or higher because an impurity lithium N-methylaminobutyrate (LMAB), which is produced in the case where an organic solvent to be used for production of lithium sulfide is N-methyl-2-pyrrolidone (NMP), dissolves in an organic solvent at a temperature of 100° C. LMAB is dissolved in an organic solvent for washing to be removed from lithium sulfide.

The organic solvent to be used for washing is preferably an aprotic polar solvent. More preferably, an aprotic organic solvent to be used for production of lithium sulfide is identical to an aprotic polar organic solvent to be used for washing.

Examples of the aprotic polar organic solvent to be preferably used for washing include aprotic polar organic compounds such as an amide compound, a lactam compound, a urea compound, an organic sulfur compound, and a cyclic organic phosphorus compound. The aprotic polar organic solvent may preferably be used as a single solvent or a mixed solvent.

Of the aprotic polar organic solvents, the amide compound includes N,N-dimethylformamide, N,N-diethylformamide, N,N-dimethylacetamide, N,N-dipropylacetamide, N,N-dimethylbenzoic amide, and the like.

In addition, examples of the lactam compound include: N-alkylcaprolactams such as caprolactam, N-methylcaprolactam, N-ethylcaprolactam, N-isopropylcaprolactam, N-isobutylcaprolactam, N-normalpropylcaprolactam, N-normalbutylcaprolactam, and N-cyclohexylcaprolactam; N-methyl-2-pyrrolidone (NMP); N-ethyl-2-pyrrolidone; N-isopropyl-2-pyrrolidone; N-isobutyl-2-pyrrolidone; N-normalpropyl-2-pyrrolidone; N-normalbutyl-2-pyrrolidone; N-cyclohexyl-2-pyrrolidone; N-methyl-3-methyl-2-pyrrolidone; N-ethyl-3-methyl-2-pyrrolidone; N-methyl-3,4,5-trimethyl-2-pyrrolidone; N-methyl-2-piperidone; N-ethyl-2-piperidone; N-isopropyl-2-piperidone; N-methyl-6-methyl-2-piperidone; and N-methyl-3-ethyl-2-piperidone.

Examples of the organic sulfur compound include dimethylsulfoxide, diethylsulfoxide, diphenylene sulfone, 1-methyl-1-oxosulfolane, and 1-phenyl-1-oxosulfolane.

Various aprotic organic compounds may be used alone, as a mixture of two or more kinds thereof, or as a mixture with another solvent component which causes no problem for attaining the object of the present invention as the aprotic organic solvent.

Of the various aprotic polar organic solvents, N-alkylcaprolactam and N-alkylpyrrolidone are preferred, and N-methyl-2-pyrrolidone (NMP) is particularly preferred.

An amount of the organic solvent to be used for washing is not particularly limited. The number of washing is not particularly limited, but washing is preferably conducted twice or more.

Washing is preferably conducted under an inert gas such as nitrogen or argon.

Washed lithium sulfide is dried at a temperature of a boiling point of the aprotic organic solvent used for washing or higher, in a stream of an inert gas such as nitrogen, under normal pressure or reduced pressure, and for 5 min or more, preferably about 2 to 3 hours or more, to thereby obtain lithium sulfide to be used in the present invention.

Commercially available products can be used as one or more components selected from diphosphorus pentasulfide, elemental phosphorus, and elemental sulfur to be used in the present invention as long as the products have high purity.

The solid electrolyte (vitreous electrolyte or lithium ion conductive inorganic solid electrolyte) obtained by the method of the present invention may be incorporated into a lithium battery without any particular limitation, and may be applied to a known embodiment to be used.

For example, in a lithium battery including a sealed dead plate, an insulating packing, electrodes, a positive plate, a positive lead, a negative plate, a negative lead, a solid electrolyte, and an insulating ring in a battery case, the solid electrolyte is formed into a sheet and incorporated into the battery.

Examples of a shape of the lithium battery include a coin, a button, a sheet, a laminate, a cylindrical shape, a flat shape, a rectangular shape, and a large shape to be used for an electric automobile or the like.

The solid electrolyte obtained by the method of the present invention can be used for a lithium battery of a personal digital assistance, a portable electronic device, a domestic small electronic energy storage device, a two-wheeled motor vehicle using a motor as a power source, an electric automobile, a hybrid electric automobile, or the like, but its use is not particularly limited to the lithium battery described above.

Invention 2 of the present invention will be described below.

The lithium ion conductive inorganic solid electrolyte of the present invention can be produced from lithium sulfide and one or more components selected from diphosphorus pentasulfide, elemental phosphorus, and elemental sulfur.

To be specific, the lithium ion conductive inorganic solid electrolyte of the present invention can be produced by conducting a melt reaction of lithium sulfide and one or more components selected from diphosphorus pentasulfide, elemental phosphorus, and elemental sulfur as raw materials, and rapidly cooling the resultant.

Alternatively, the lithium ion conductive inorganic solid electrolyte of the present invention can be produced by a mechanical milling method using lithium sulfide and one or more components selected from diphosphorus pentasulfide, elemental phosphorus, and elemental sulfur as raw materials.

Lithium sulfide to be used in the present invention contains a total content of a lithium salt of sulfur oxide of 0.15 mass % or less, and preferably 0.1 mass % or less, and a content of lithium N-methylaminobutyrate of 0.15 mass % or less, and preferably 0.1 mass % or less.

In the case where the total content of a lithium salt of sulfur oxide is 0.15 mass % or less, an electrolyte to be obtained is vitreous electrolyte (completely amorphous).

That is, in the case where the total content of a lithium salt of sulfur oxide is more than 0.15 mass %, an electrolyte to be obtained is a crystallized product having low ionic conductivity from the beginning.

Further, no changes occur even when the crystallized product is subjected to the following heat treatment, and a lithium ion conductive inorganic solid electrolyte having high ionic conductivity cannot be obtained.

In the case where the content of lithium N-methylaminobutyrate is 0.15 mass % or less, a degraded product of lithium N-methylaminobutyrate does not degrade cycle performance of a lithium battery.

Thus, for obtaining an electrolyte having high ionic conductivity, lithium sulfide containing reduced impurities must be used.

A mixed molar ratio of the lithium sulfide to one or more components selected from diphosphorus pentasulfide, elemental phosphorus, and elemental sulfur is generally 50:50 to 80:20, and preferably 60:40 to 75:25.

In the case where lithium sulfide and one or more components selected from diphosphorus pentasulfide, elemental phosphorus, and elemental sulfur are used as raw materials, a melt reaction temperature is generally 500 to 1,000° C., preferably 600 to 1,000° C., and more preferably 900 to 1,000° C., and a melt reaction time is generally 1 hour or more, and preferably 6 hours or more.

A rapid cooling temperature of the reaction product is generally 10° C. or lower, and preferably 0° C. or lower, and a cooling rate thereof is about 1 to 10,000 K/sec, and preferably 1 to 1,000 K/sec.

The mechanical milling method using lithium sulfide and one or more components selected from diphosphorus pentasulfide, elemental phosphorus, and elemental sulfur as raw materials can be conducted at room temperature.

The mechanical milling method allows production of a vitreous electrolyte (completely amorphous) at room temperature and thus has an advantage in that a vitreous electrolyte of a charged composition can be obtained without heat decomposition of the raw materials.

Further, the mechanical milling method has an advantage in that the method allows formation of vitreous electrolyte into fine powder concurrent with the production of the vitreous electrolyte (completely amorphous).

For the mechanical milling method, various devices may be employed, but a planetary ball mill is particularly preferably employed for the mechanical milling method.

In the planetary ball mill, a pot rotates while a table revolves, whereby the planetary ball mill can efficiently generate very high impact energy.

Revolution speed and time of the mechanical milling method are not particularly limited. However, a high revolution speed increases a formation rate of the vitreous electrolyte (completely amorphous), and a long revolution time increases a conversion rate of the raw materials into the vitreous electrolyte.

The thus-obtained electrolyte is vitreous electrolyte (completely amorphous) and generally has an ionic conductivity of 1.0×10⁻⁵ to 8.0×10⁻⁵ (S/cm).

The lithium ion conductive inorganic solid electrolyte of the present invention is preferably produced by further subjecting the vitreous electrolyte described above to heat treatment.

A heat treatment temperature is generally about 170 to 370° C., preferably 180 to 330° C., and more preferably 200 to 290° C. A heat treatment time varies depending on the heat treatment temperature, but is generally 1 min or more, and preferably 5 min to 24 hours.

A partially or completely crystallized lithium ion conductive inorganic solid electrolyte can be obtained through the heat treatment.

The thus-obtained lithium ion conductive inorganic solid electrolyte generally has an ionic conductivity of 7.0×10⁻⁴ to 3.0×10⁻³ (S/cm).

A method of producing lithium sulfide to be used in Invention 2 is not particularly limited as long as it is a method capable of at least reducing the above-mentioned impurities.

For example, lithium sulfide can be produced by the method described in Invention 1.

Further, a method of purifying lithium sulfide obtained as described above is not particularly limited.

A preferred example of the purification method is a method described in Japanese Patent Application No. 2003-363403.

A specific example of the purification method is the purification method described in Invention 1.

Commercially available products can be used as one or more components selected from diphosphorus pentasulfide, elemental phosphorus, and elemental sulfur to be used in the present invention.

The lithium ion conductive inorganic solid electrolyte having excellent properties as described above is used to thereby obtain an all-solid lithium battery having excellent long-term stability.

An example of the negative electrode active material having a reduction potential of 0.5 V or less of the present invention includes: a carbon material; or a substance containing lithium ions inserted between layers of the carbon material. A preferred example thereof is a carbon material.

The carbon material has an electronegative potential of a great extent of about 0.1 V and is excellent for producing a lithium battery having high energy density.

In the case where the carbon material represented by graphite is used as a negative electrode active material of a lithium battery, the lithium ions are inserted between layers of the carbon material during a state of charge. In a complete discharge state, the lithium ions between the layers are released, and the original carbon material is obtained.

Examples of the positive electrode active material having an operating potential of 3 V or more of the present invention include; a lithium salt of a metallic acid such as LiCoO₂, LiNiO₂, or LiMn₂O₄; MnO₂; and V₂O₅.

However, the carbon material as the negative electrode active material of the present invention containing no lithium ions inserted between layers is stable, so a lithium battery is preferably formed by using a carbon material containing no lithium ions for practical use.

Thus, preferred examples of the positive electrode active material include compounds each containing lithium ions, such as LiCoO₂, LiNiO₂, and LiMn₂O₄.

These compounds each preferably exhibit a potential of 4 V with respect to a lithium potential with release of lithium ions.

Further, of these compounds, lithium cobaltate (LiCoO₂) is most preferred.

When incorporated into an all-solid lithium battery, the lithium ion conductive inorganic solid electrolyte of the present invention, with no particular limitations, may be applied to a known embodiment to be used.

For example, in an all-solid lithium battery including a sealed dead plate, an insulating packing, electrodes, a positive plate, a positive lead, a negative plate, a negative lead, a solid electrolyte, and an insulating ring in a battery case, the solid electrolyte is formed into a sheet and incorporated into the battery to be used.

Examples of a shape of the all-solid lithium battery include a coin, a button, a sheet, a laminate, a cylindrical shape, a flat shape, a rectangular shape, and a large shape to be used for an electric automobile or the like.

As the method of producing an all-solid lithium battery by using the lithium ion conductive inorganic solid electrolyte of the present invention, any conventionally known method may be employed.

The lithium ion conductive inorganic solid electrolyte of the present invention can be used for an all-solid lithium battery of a personal digital assistance, a portable electronic device, a domestic small electronic energy storage device, a two-wheeled motor vehicle using a motor as a power source, an electric automobile, a hybrid electric automobile, or the like, but its use is not particularly limited to the lithium battery described above.

### EXAMPLES

Next, the present invention will be described more specifically by referring to examples and comparative examples, but the present invention is not limited to the examples in any way.

### Reference Example 1

(1) Production of Lithium Sulfide

Lithium sulfide was produced by a method according to a first embodiment (two-step method) of Patent Document 1.

To be specific, 3,326.4 g (33.6 mol) of N-methyl-2-pyrrolidone (NMP) and 287.4 g (12 mol) of lithium hydroxide were charged into a 10-L autoclave equipped with a stirring blade, and a reaction liquid was stirred at 300 rpm and heated to 130° C.

After heating, hydrogen sulfide was blown into the liquid at a supply rate of 3 liter/min for 2 hours.

Next, the reaction liquid was heated in a stream of nitrogen (200 cm³/min) such that hydrogen sulfide was partially removed from reacted hydrogen sulfide.

Water produced as a by-product of the reaction of the hydrogen sulfide and lithium hydroxide started to evaporate with heating, and the water was condensed by a condenser and extracted out of the system.

The temperature of the reaction liquid increased with distillation of water out of the system. Heating was stopped at a temperature of 180° C., and the reaction liquid was maintained at a constant temperature.

After completion of the reaction of removing hydrogen sulfide (about 80 min), the reaction was stopped to thereby obtain lithium sulfide.

(2) Purification of Lithium Sulfide

NMP in 500 ml of the slurry reaction solution (NMP-lithium sulfide slurry) obtained in the above section (1) was decanted, and 100 ml of dehydrated NMP was added. The whole was stirred at 105° C. for about 1 hour.

NMP was decanted at this temperature.

Additional 100 ml of NMP was added, and the whole was stirred at 105° C. for 1 hour. NMP was decanted at this temperature. The same operation was repeated four times in total.

After the decantation, the resultant was dried at 230° C. under reduced pressure for 3 hours.

A content of impurities in the obtained lithium sulfide was measured.

Table 1 shows the obtained results.

Note that the content of impurities such as lithium sulfite (Li₂SO₃), lithium sulfate (Li₂SO₄), lithium thiosulfate (Li₂S₂O₃), and lithium N-methylaminobutyrate (LMAB) was determined by an ion chromatography method.

### Reference Example 2

The content of impurities in commercially available lithium sulfide (available from Sigma-Aldrich Japan K.K.) was measured.

Table 1 shows the obtained results.

TABLE 1

| | Li₂SO₃ | Li₂SO₄ | Li₂S₂O₃ | LMAB |
|---|---|---|---|---|
| | (mass %) | (mass %) | (mass %) | (mass %) |
| Reference | <0.0008 | <0.001 | <0.001 | 0.04 |
| Example 1 | | | | |
| Reference | — | 1 | 0.78 | 0 |
| Example 2 | | | | |

### Example 1

0.6508 g (0.01417 mol) of high purity lithium sulfide of Reference Example 1 and 1.3492 g (0.00607 mol) of diphosphorus pentasulfide were mixed sufficiently. The mixture was introduced into a carbon-coated quartz glass tube, and the tube was sealed under vacuum.

Next, the tube was placed into a vertical reaction furnace and heated to 900° C. over 4 hours. A melt reaction was conducted at this temperature for 2 hours.

After completion of the reaction, the quartz tube was charged into ice water for rapid cooling.

The quartz tube was opened, and a powder sample of the obtained melt reaction product was subjected to X-ray diffraction measurement. As a result, peaks of lithium sulfide and diphosphorus pentasulfide disappeared, and the result confirmed that vitrification proceeded (see FIG. 1, CPS represents an X-ray reflection intensity).

An electric conductivity of the powder sample was measured by an alternating current impedance method (measurement frequency of 100 Hz to 15 MHz). As a result, the powder sample had an ionic conductivity of 1.3×10⁻⁴ S/cm at room temperature.

Table 2 shows the obtained results.

### Example 2

The vitreous electrolyte obtained in Example 1 was subjected to heat treatment at 250° C. for 30 min.

A powder sample of the obtained heat treated product was subjected to X-ray diffraction measurement. The result confirmed that partial crystallization proceeded (see FIG. 2, CPS represents an X-ray reflection intensity).

An electric conductivity of the powder sample was measured by an alternating current impedance method. As a result, the powder sample had an ionic conductivity of 8.4×10⁻⁴ S/cm at room temperature.

Table 2 shows the obtained results.

### Comparative Example 1

The melt reaction and the rapid cooling operation were conducted in the same manner as in Example 1 except that commercially available lithium sulfide (available from Sigma-Aldrich Japan K.K.) of Reference Example 2 was used instead of high purity lithium sulfide of Reference Example 1.

A powder sample of the obtained melt reaction product was subjected to X-ray diffraction measurement. The result confirmed that no vitrification proceeded in the reaction product, and that the reaction product was a crystallized product (see FIG. 1).

An electric conductivity of the powder sample was measured by an alternating current impedance method. As a result, the powder sample had an ionic conductivity of 3.6×10⁻⁵ S/cm at room temperature.

Table 2 shows the obtained results.

### Comparative Example 2

The crystallized electrolyte obtained in Comparative Example 1 was subjected to heat treatment at 250° C. for 30 min.

A powder sample of the obtained heat treated product was subjected to X-ray diffraction measurement. The result confirmed that the powder sample was the same as that of Comparative Example 1 (see FIG. 1).

Further, an electric conductivity of the powder sample was measured by an alternating current impedance method. As a result, the powder sample had an ionic conductivity of 5.9×10⁻⁵ S/cm at room temperature.

Table 2 shows the obtained results.

TABLE 2

Ionic conductivity (S/cm)

| | Before heat treatment | After heat treatment |
|---|---|---|
| Example | Example 1 | Example 2 |
| | 1.3 × 10⁻⁴ | 8.4 × 10⁻⁴ |
| Comparative | Comparative example 1 | Comparative example 2 |
| Example | 3.6 × 10⁻⁵ | 5.9 × 10⁻⁵ |

### Example 3

A lithium battery was produced as described below by using carbon graphite (SFG-15, available from TIMCAL) as a negative electrode active material and lithium cobaltate (LiCoO₂) as a positive electrode active material. Battery properties of the lithium battery were evaluated.

The lithium ion conductive solid electrolyte obtained in Example 2 and carbon graphite were mixed in a mass ratio of 1:1, to thereby prepare a negative electrode material.

Lithium cobaltate and the lithium ion conductive solid electrolyte were mixed in a mass ratio of 8:5, to thereby prepare a positive electrode material.

The negative electrode material (10 mg), the positive electrode material (20 mg), and the lithium ion conductive solid electrolyte (150 mg) placed therebetween were formed into three-layer pellets, to thereby prepare a measurement cell.

The measurement cell was charged and discharged at a constant current of 10 μA for evaluating the battery properties. As a result, an initial charge and discharge efficiency was 85.8%.

FIG. 3 shows the charge and discharge properties.

Note that a vertical axis represents terminal voltage (V) and a horizontal axis represents capacity with respect to 1 g of lithium cobaltate.

FIG. 4 shows charge and discharge cycle properties.

The battery had an operating potential [a potential difference of a positive electrode in the case of a standard electrode potential of a lithium metal as a standard (0 V)] of 3.5 V, and a potential of the negative electrode active material [a potential difference of a negative electrode in the case of a standard electrode potential of a lithium metal as a standard (0 V)] of 0.1 V.

### Comparative Example 3

The measurement cell was produced in the same manner as in Example 3 except that GeS₂—Li₂S—P₂S₅ [thio-LISICON-based electrolyte, composition ratio: Li; 0.35, Ge; 0.25, P; 0.75, S; 4] was used as a solid electrolyte instead of the lithium ion conductive solid electrolyte of Example 2. The battery properties were studied, and the initial charge and discharge efficiency was 16.5%.

FIG. 5 shows the charge and discharge properties.

Note that a vertical axis represents terminal voltage (V) and a horizontal axis represents capacity with respect to 1 g of the thio-LISICON-based electrolyte.

The battery had a potential of the negative electrode active material of 0.1 V, but the electrolyte was reduced by the negative electrode active material. Thus, the battery did not operate as a secondary battery.

### INDUSTRIAL APPLICABILITY

The solid electrolyte obtained by the method of the present invention can be used for a lithium battery of a personal digital assistance, a portable electronic device, a domestic small electronic energy storage device, a two-wheeled motor vehicle using a motor as a power source, an electric automobile, a hybrid electric automobile, or the like, but its use is not limited to the lithium battery described above. Further, the all-solid lithium battery of the present invention can be used as a battery for a personal digital assistance, a portable electronic device, a domestic small electronic energy storage device, a two-wheeled motor vehicle using a motor as a power source, an electric automobile, a hybrid electric automobile, or the like.

1. A method of producing a vitreous electrolyte, comprising: conducting a melt reaction of lithium sulfide containing 0.15 mass % or less of each of a lithium salt of sulfur oxide and lithium N-methylaminobutyrate, and one or more components selected from diphosphorus pentasulfide, elemental phosphorus, and elemental sulfur; and rapidly cooling the resultant.

2. A method of producing a vitreous electrolyte according to claim 1, wherein the melt reaction is conducted on 50 to 80 mol % of lithium sulfide and 20 to 50 mol % of one or more components selected from diphosphorus pentasulfide, elemental phosphorus, and elemental sulfur.

3. A method of producing a vitreous electrolyte according to claim 1 or 2, wherein a cooling rate is 1 to 10,000 K/sec.

4. A method of producing a lithium ion conductive inorganic solid electrolyte, comprising subjecting the vitreous electrolyte obtained by the method according to any one of claims 1 to 3 to heat treatment.

5. A method of producing a lithium ion conductive inorganic solid electrolyte according to claim 4, wherein the heat treatment is conducted at 170 to 370° C.

6. A lithium battery, which is produced by using the vitreous electrolyte obtained by the method according to any one of claims 1 to 3.

7. A lithium battery, which is produced by using the lithium ion conductive inorganic solid electrolyte obtained by the method according to claim 4 or 5.

8. A lithium battery, which is obtained by using a positive electrode active material having an operating potential of 3 V or more, a negative electrode active material having a reduction potential of 0.5 V or less, and a lithium ion conductive inorganic solid electrolyte in contact with at least the negative electrode active material, the lithium ion conductive inorganic solid electrolyte being produced from lithium sulfide and one or more components selected from diphosphorus pentasulfide, elemental phosphorus, and elemental sulfur.

9. A lithium battery according to claim 8, wherein:
lithium sulfide is obtained by reacting lithium hydroxide and hydrogen sulfide in an organic solvent, removing hydrogen sulfide from the resultant, then purifying the resultant; and
lithium sulfide contains a total content of a lithium salt of sulfur oxide of 0.15 mass % or less and a content of lithium N-methylaminobutyrate of 0.15 mass % or less.
